(19) United States
(12) Patent Application Publication
(10) Pub. No.: US 2019/0120767 A1
(43) Pub. Date: Apr. 25, 2019

(54) Super-Resolution Fluorescence Microscopy Method Using Improved Drift Compensation Markers

(71) Applicant: Ultivue, Inc., Cambridge, MA (US)

(72) Inventors: Michael Jules NATAN, Weston, MA (US); Stephanie Rae HENNEK, Medford, MA (US); Mael MANESSE, Medford, MA (US)

(21) Appl. No.: 16/096,073

(22) PCT Filed: Apr. 25, 2017
(86) PCT No.: PCT/US2017/029276

§ 371 Date: Oct. 24, 2018

Related U.S. Application Data
(60) Provisional application No. 62/327,570, filed on Apr. 26, 2016.

(51) Int. Cl. G01N 21/64; G01N 21/65

(52) U.S. Cl. CPC G01N 21/6458; B82Y 35/00; G01N 21/658

(57) ABSTRACT

A super-resolution fluorescence microscopy method comprises (a) providing a drift compensation marker, wherein (i) the drift compensation marker comprises a coated plasmonic particle; (ii) the drift compensation marker comprises an anisotropic plasmonic particle; and/or (iii) the drift compensation marker comprises a plasmonic particle comprising at least one reporter molecule on the surface of the plasmonic particle or on the surface of a coating; (b) performing super-resolution fluorescence microscopy; (c) using the drift compensation marker to improve the resolution of the super-resolution fluorescence microscopy. A super-resolution fluorescence microscopy method alternatively comprises (a) providing a drift compensation marker comprising a nonplasmonic Raman-active particle and wherein optionally the drift compensation marker comprises a coated nonplasmonic Raman-active particle and/or optionally the drift compensation marker comprises an anisotropic nonplasmonic Raman-active particle; (b) performing super-resolution fluorescence microscopy; (c) using the drift compensation marker to improve the resolution of the super-resolution fluorescence microscopy.

### CROSS-REFERENCE TO RELATED APPLICATIONS

This application claims the benefit of priority of U.S. Provisional Application No. 62/327,570, filed Apr. 26, 2016, which is incorporated by reference herein in its entirety for any purpose.

### DESCRIPTION

### Field

Improved Drift Compensation Markers for Fluorescence Microscopy

### BACKGROUND

Fluorescence microscopy (FM) is the act of using a fluorescence microscope, an optical microscope that uses fluorescence, phosphorescence, or excited state emissions from organic or inorganic molecules, materials and/or substances, to generate an image.

The advent and widespread acceptance of nanoscale microscopy techniques (e.g. super-resolution fluorescence microscopy¹⁻⁸ and electron microscopy) has greatly expanded research and discovery capabilities on biological and non-biological specimens. Such imaging tools are capable of overcoming the diffraction limit of light to visualize nanoscale (<50 nm) features at high resolution. Often, these techniques rely on single-molecule detection and localization which necessitate recording many image stacks over a long period of time. Due to the long imaging times and small feature scale, sample drift is highly problematic and must be corrected to obtain high quality images. Small environmental disturbances (e.g. mechanical vibrations and thermal fluctuations) can cause sample drift on the order of 0.1-10 nm/s, while image acquisition times can stretch from minutes to hours.⁹⁻¹¹ Thus, to obtain a resolution of <50 nm with localization-based microscopy, sample drift must be corrected. Note that drift correction is alternately called drift compensation, drift feedback, drift minimization, etc.

Current methods of drift correction fall into three major categories which can be used separately or combined including: 1) fiducial-based,^{6,9} 2) software-based,¹²⁻¹⁵ and 3) mechanical-based corrections.^{10,16-19} There are several drawbacks apparent with all current methods. Software-based correction relying on frame-to-frame cross-correlation of spots decouples each spot from the original reference frame, lacks ultrahigh resolution (<20 nm), and is not broadly applicable to experiments involving sample mobility such as molecular tracking. Mechanical-based correction requires additional hardware, including costly detectors and piezo stages.

Fiducial-based drift correction using drift compensation markers is attractive because it can be implemented for any sample type, yield ultra-high resolution (<5 nm), and be used for either real-time or a posteriori correction. At the very minimum, drift compensation markers must be constantly detectable in the experimental field of view for the duration of the imaging time; this makes the choice for drift compensation marker composition non-trivial. Drift compensation markers comprising gold nanoparticles^{18,20} or fluorescent beads^{21,22} have been proposed and implemented previously.

However, with the present invention, Applicant has observed that prior art materials suffer from one or more of the following drawbacks: 1) particles are not stationary over the experimental duration; 2) signal intensity is dependent on microscope optics, including but not limited to filters; 3) particle brightness is not optimized for illumination source; 4) particles are not inert to surrounding environment and may interact (e.g. plasmonically) with molecules in solution resulting in intensity fluctuations; 5) aggregation of particles leads to inconsistent brightness and dispersion in the field of view, and 6) the reflectivity of prior drift control markers such as gold nanoparticles is typically wavelength dependent. Thus, there is an unfulfilled need for an ideal drift marker that can overcome all of the above limitations of the current technology.

Elaborating on one of the problems outlined above, the prior art materials produce a signal received by the detector that is a function of the quality of the filter set used. In a typical fluorescence microscopy experiment, filters are used to block laser light from reaching the detector. This is required because the intensity of the laser excitation is hundreds of times higher than the fluorescence signal of interest, and since the fluorescent photons are shifted to lower energies (i.e. lower frequencies, longer wavelengths) relative to the laser excitation wavelength, bandpass filters can be used to “reject” the laser light and pass the longer-wavelength fluorescence. However, the reflectivity signal from the drift control marker is elastically scattered, that is, it is at the same energy and wavelength as the excitation photons. Thus, the only reason that the reflectivity from DCM can be observed at all is that the bandpass filters are imperfect, i.e. they do not reject 100% of the photons at the excitation wavelength. Thus, some of the photons reflected by the DCM reach the detector. Typical rejections by bandpass filters are 99%, 99.9%, 99.999%, or 99.9999% of input photons. Table 1 lists the rejection at λ=635 nm for a series of commercially-available bandpass filters.

TABLE 1
Commercially-Available Bandpass Filters

| | | Rejection at |
|---|---|---|
| Filter | Optical density at 635 nm | 635 m (%) |
| Chroma AT690/50 m | 6.02 OD | 99.999905 |
| Chroma ET700/75 m | 8.00 OD | 99.999999 |
| Chroma ET667/30 m | 7.12 OD | 99.999992 |

Thus, depending on the bandpass filter chosen, a DCM may appear as very bright, bright, fairly dim, or very dim. This makes it very difficult to choose a DCM that could be widely applicable.

The drawbacks of commonly used drift markers composed of gold nanoparticles are demonstrated in FIGS. 3A and 4. FIG. 3A illustrates the effects of the movement of poorly adsorbed gold nanoparticles. FIG. 3A shows the signal observed over time (16000 frames, about 26 minutes) for a 60 nm gold nanoparticle on a biological sample. The time trace signal is normalized to 1 when the particle is observed. The signal stays constant until frame 7000, where it then goes down to 0, which corresponds to the particle not being observed in the field of view for the remainder of the frames. This particular particle could thus not be used as an effective DCM. FIG. 4 illustrates signal fluctuation observed with gold nanoparticles in presence of a solution containing free fluorescent molecule in solution, over 20 000 frames. In FIG. 4A, the particle highlighted as number 2 is a gold nanoparticle adsorbed on a biological sample with fluorescent molecules in solution. The three images in FIG. 4A were taken at different times during the experiment. The center frame (frame 14963) clearly shows an increase of signal coming for particle number 2 compared to the left and right frames. This increase is signal is due to the interaction between the particle and free fluorescent molecules in solution. The behavior is repeated several times during the experiment, as shown in FIG. 4C. The average signal of each DCM was recorded during the experiment. FIG. 4C corresponds to the signal from the 60 nm gold nanoparticle, and displays several intense and sudden increase, which decrease the effectiveness of this particle as a DCM.

Various plasmonic nanoparticles have been used contexts other than super-resolution fluorescence microscopy; however, the particles were employed in the other contexts for different purposes and achieved different goals. For example, colloidal gold and silver nanoparticles have been used as nanocatalysts, as optical detection labels in chemical and biological assays (e.g. lateral flow immunoassays), as electron-dense labels in transmission electron microscopy and scanning electron microscope, as contrast agents in photoacoustic imaging, and coloring materials in glasses, as heat-directing materials, and as substrates for SERS and SERRS (both techniques employing a Raman spectrometer).

Keeping in mind the need for drift compensation markers and the deficiencies of prior art drift compensation markers, the art requires improved drift compensation markers for increasing resolution and accuracy in super-resolution fluorescence microscopy.

### SUMMARY

In accordance with the description, a super-resolution fluorescence microscopy method comprises (a) providing a drift compensation marker, wherein (i) the drift compensation marker comprises a plasmonic particle, wherein the drift compensation marker comprises a coated plasmonic particle; the drift compensation marker comprises an anisotropic plasmonic particle; and/or the drift compensation marker comprises a plasmonic particle comprising at least one reporter molecule on the surface of the plasmonic particle, on the surface of a coating, or embedded within a coating; or (ii) the drift compensation marker comprises a nonplasmonic Raman-active particle and wherein optionally the drift compensation marker comprises a coated nonplasmonic Raman-active particle; and/or optionally the drift compensation marker comprises an anisotropic nonplasmonic Raman-active particle; (b) performing super-resolution fluorescence microscopy; (c) using the drift compensation marker to improve the resolution of the super-resolution fluorescence microscopy.

In some embodiments, the super-resolution fluorescence microscopy method is capable of resolution of better than about 250 nm. In some embodiments, the super-resolution fluorescence microscopy method is capable of resolution from about 200 nm to 5 nm. In some embodiments, the super-resolution microscopy method is capable of resolution from about 100 nm to 5 nm. In some embodiments, the resolution of the super-resolution fluorescence microscopy method is about 50 nm or better. In some embodiments, resolution of the super-resolution fluorescence microscopy method is about 40 nm, 30 nm, 20 nm, 15 nm, 10 nm, 5 nm, or better.

In some embodiments, the method employs a laser having a wavelength in the Ultra-violet (UV, from about 10 to 400 nm), visible (from about 400 to 750 nm), Infra-Red (IR, from about 750 nm to 1 mm), or microwave (from about 1 mm to 0.3 m) range.

In some embodiments, the plasmonic particle comprises at least one of gold, silver, platinum, copper, aluminum, carbon, cobalt, zinc, or palladium, as well as their alloys, composites, or hybrid layered materials such as a core of one plasmonic material with a shell of a different plasmonic material. In some embodiments, the plasmonic particle comprises at least one of gold, silver, copper, and carbon.

In some embodiments, the nonplasmonic, Raman-active particle comprises at least one of diamond, diamond-like material, graphite, graphene, reduced graphene, and graphene oxide. In some embodiments, the plasmonic or nonplasmonic Raman-active particle is an isotropic particle from about 2 to 300 nm in diameter. In some embodiments, the plasmonic or nonplasmonic Raman-active particle is an anisotropic particle with a diameter from about 2 to 300 nm in any dimension. In some embodiments, the plasmonic or nonplasmonic Raman-active particle is a one-dimensional nanowire with a diameter from about 1 nm to about 500 μm in any direction.

In some embodiments, the plasmonic or nonplasmonic Raman-active particle is coated with at least one transparent coating. In some embodiments, the plasmonic particle or nonplasmonic Raman-active is coated with two or more layers of transparent coating. In some embodiments, the transparent coating comprises at least one of SiO₂, TiO₂, Fe₂O₃, CuO, ZnO, Y₂O₃, ZrO₂, In₂O₃, SnO₂, Sb₂O₅, WO₃, and PbO. In some embodiments, the transparent coating comprises at least one of metals, metal nitrides, unimolecular molecular layer-type coatings such as self-assembled organothiol monolayers (SAMs), and any synthetic or naturally occurring macromolecule, such as a lipid, carbohydrate, polysaccharide, protein, polymer, glycoproteins, glycolipids. In some embodiments, the thickness of the coating is from about 1 to 20 nm. In some embodiments, the thickness of the coating is from about 1 to 100 nm. In some embodiments, the thickness of the coating is about 100 nm or more.

In some embodiments, the plasmonic or nonplasmonic Raman-active particle is isotropic. In some embodiments, the plasmonic or nonplasmonic Raman-active particle is anisotropic. In some embodiments, the anisotropic plasmonic particle produces at least two distinct λ max signals when illuminated. In some embodiments, the anisotropic plasmonic or nonplasmonic Raman-active particle is a non-spherical geometric shape comprising elliptical, triangular, rod, prism, plate, disk, hollow sphere, star, and wire shape.

In some embodiments, the reporter molecule comprises excitable and radiative molecules comprising but not restricted to fluorophores, luminophores, chemiluminescent, phosphorescent, or Raman-active molecules.

In some embodiments, the drift compensation marker comprises reporter molecules forming a sub-monolayer, a complete monolayer, or a multilayer assembly on the surface of the plasmonic particle or a coating, or within a coating. In some embodiments, the drift compensation marker is coated and the plasmonic or nonplasmonic Raman-active particle is anisotropic. In some embodiments, the drift compensation marker is coated and the plasmonic particle comprises at least one reporter molecule on the surface of the plasmonic particle, on the surface of a transparent coating, or embedded within a transparent coating.

In some embodiments, the plasmonic particle has a reporter molecule on its surface and is coated with at least one transparent coating. In some embodiments, the plasmonic particle has a first transparent coating, at least one reporter molecule on the surface of the coating, and a second outer transparent coating. In some embodiments, the drift compensation marker comprises a plasmonic particle that is anisotropic and wherein the plasmonic particle comprises at least one reporter molecule on the surface of the plasmonic particle, on the surface of a transparent coating, or embedded within a transparent coating. In some embodiments, the drift compensation marker comprises a coated plasmonic particle having at least one reporter on the surface of the plasmonic particle, on the surface of a transparent coating, or embedded within a transparent coating, further wherein the plasmonic particle is anisotropic.

Additional objects and advantages will be set forth in part in the description which follows, and in part will be obvious from the description, or may be learned by practice. The objects and advantages will be realized and attained by means of the elements and combinations particularly pointed out in the appended claims.

It is to be understood that both the foregoing general description and the following detailed description are exemplary and explanatory only and are not restrictive of the claims.

The accompanying drawings, which are incorporated in and constitute a part of this specification, illustrate one (several) embodiment(s) and together with the description, serve to explain the principles described herein.

### BRIEF DESCRIPTION OF THE DRAWINGS

FIGS. 1A-B provide a view of microscope and an explanation of sample drift. (A) provides an optical layout of a typical inverted fluorescence microscope. Thermal and mechanical fluctuation incurred over time course of an image acquisition may cause the stage supporting the sample to move relative to the camera resulting in sample drift as shown in (B).

FIGS. 2A-E show UV-vis absorbance spectra of (A) 20 nm gold nanospheres, (B), 60 nm gold nanospheres, (C) 50 nm by 20 nm gold nanorods, (D) silica-coated SERS particles, and (E) Carbon black powder. Sources: Nanocomposix certificate of analysis (A, B, and C); Natan et al., patent WO2010138914A1 (D); Han et al., Nanoscale Res Lett, 2011, 6, 457 (E).

FIGS. 3A-B show a comparison of signal observed over time for 60 nm gold nanoparticle (A) versus silica-coated gold SERS DCMs (B). Time trace of gold nanoparticles illuminated with 640 nm demonstrates particles are not constantly observable over the course of the experiment, while SERS particles are stable and well-adhered to the surface. Time shown as number of frames, wherein 1 frame=100 ms, and total acquisition time spans over 25 minutes.

FIGS. 4A-C provide a comparison of signal observed over time for a 60 nm gold nanoparticle (2) versus a silica-coated gold SERS DCM (1). (A) shows 3 frames extracted from a 15000-frame timelapse with a mixture of gold nanoparticles (circle) and silica-coated SERS DCMs (square). The intensity versus time traces corresponding to the two particles shown in (A) are presented in (B) and (C) for the silica-coated SERS DCM and uncoated gold nanoparticle respectively. The intensity of particle 1 (in both A and B) is mostly constant over the timelapse, while particle 2 displays a “flashing” behavior with stochastic intensity changes as can be seen on A (frame 14963), and the time trace in C.

FIGS. 5A-B illustrate an example of super-resolution cellular imaging before (A) and after (B) drift correction using 60 nm gold nanoparticles as drift correction markers. A drift correction marker is identified by a white box. Images show microtubules in fixed HeLa cells observed by DNA-PAINT. Scale bar is 2 μm.

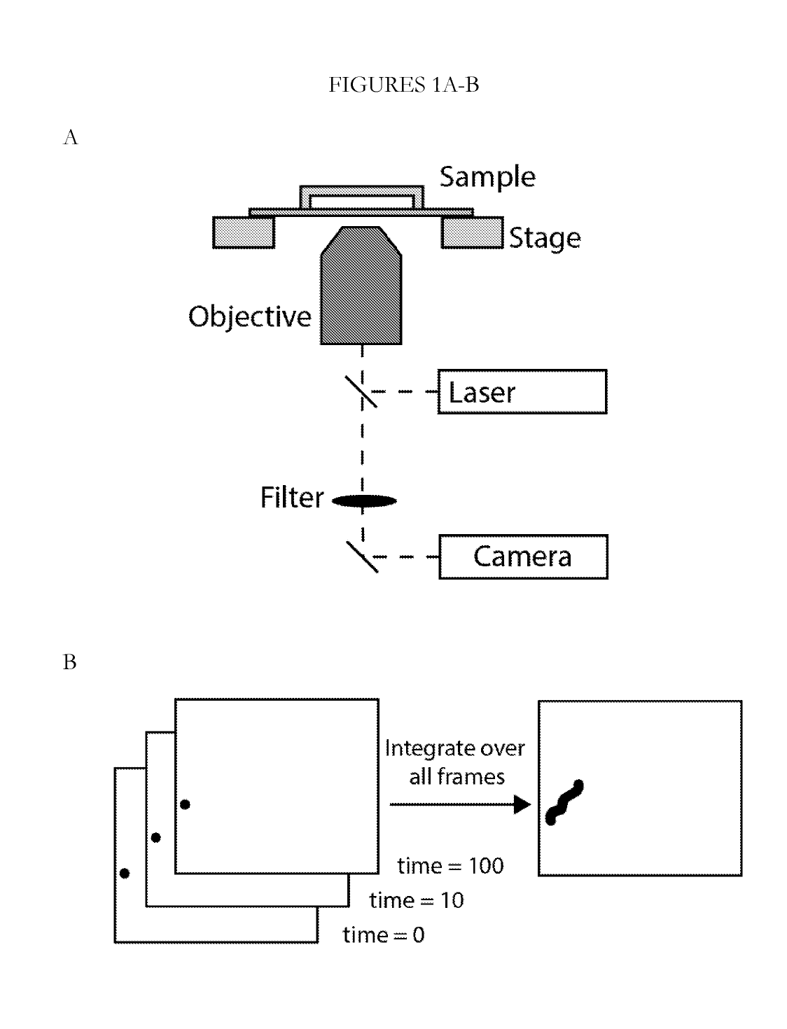

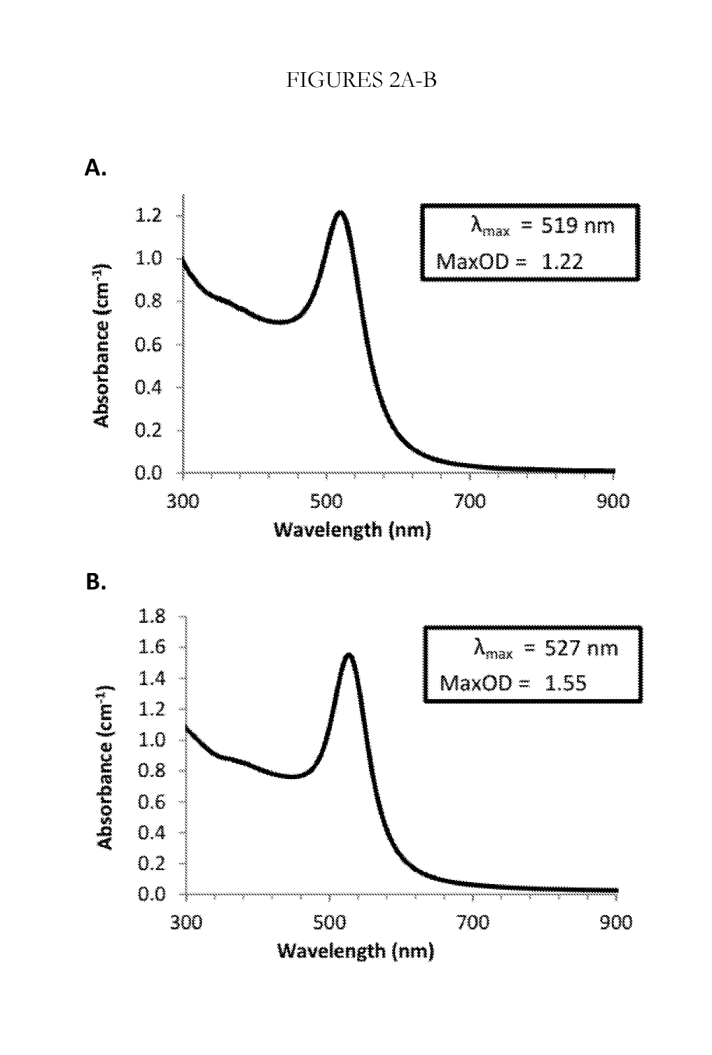

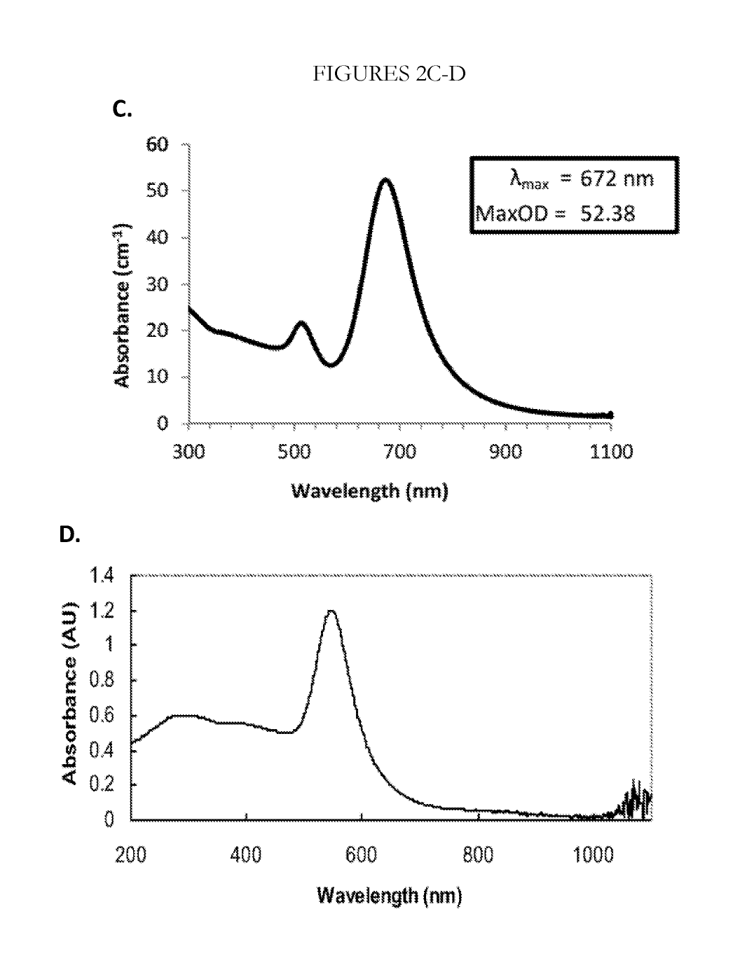

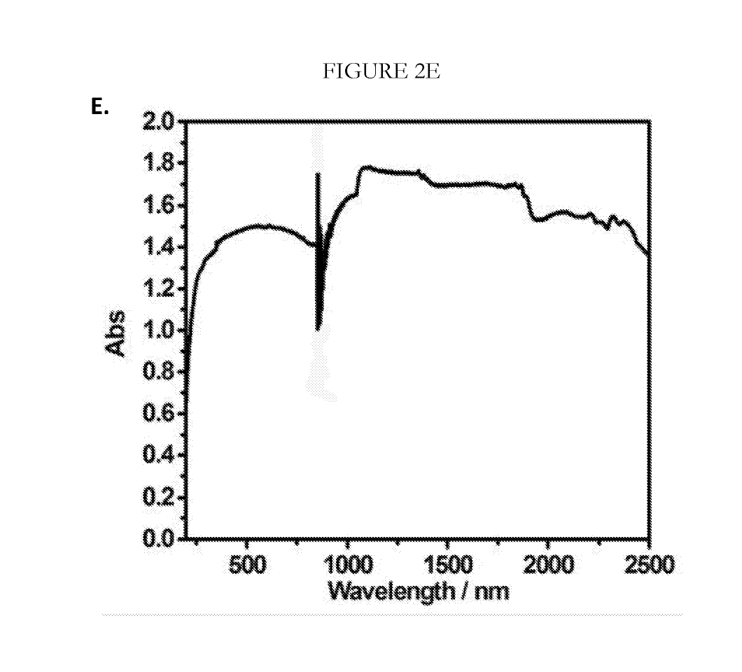

### DESCRIPTION OF THE EMBODIMENTS

### I. Improved Methods of Super-Resolution Fluorescence Microscopy

A. Description of Super-Resolution Fluorescence Microscopy

Super-resolution fluorescence microscopy is a type of light microscopy that provides images at a higher resolution than permitted by the limit of diffraction. Using visible light and high numerical aperture objectives, conventional microscopy images are limited to a resolution of about 250 nm. Super-resolution images can be taken at much higher resolution, currently as high as 5 nm. Thus, super-resolution imaging includes any microscopy techniques that result in a resolution of at least about 250 nm, 200 nm, 150 nm, 100 nm, 50 nm, 25 nm, 20 nm, 15 nm, 10 nm, or 5 nm. In some embodiments, the resolution is from about 200 nm to 5 nm, 150 to 10 nm, 100 to 5 nm. In some embodiments, the resolution may be better than 5 nm. The resolution is defined as the minimum distance between two distinguishable points. Super resolution microscopy allows the imaging of features in such proximity that they are indistinguishable with conventional microscopy tools (such as light microscopes).

Several techniques have been developed to reach sub-wavelength resolution. In biological imaging, the most often used techniques are based on the stochastic emission of fluorescent molecules, and the reconstruction of a super-resolved image by the localization of single molecules, which is the basis of single molecule localization microscopy (SMLM). Some examples of implementation of these techniques are: stochastic optical reconstruction microscopy (STORM), photoactivated localization microscopy (PALM), point accumulation for imaging in nanoscale topography (PAINT, including DNA-PAINT employing transient binding of labeled nucleotides). Other forms of super-resolution imaging include, but are not limited to, simulated emission depletion microscopy (STED), and structured illumination microscopy (SIM).

Super-resolution fluorescence microscopy does not include spectroscopy, defined as the study and measurement of spectra produced when matter interacts with or emits electromagnetic radiation, including surface enhanced Raman spectroscopy (SERS) or surface enhanced resonance Raman spectroscopy (SERRS). Super-resolution microscopy also does not include transmission electron microscopy (TEM), scanning electron microscopy (SEM), or photoacoustic imaging.

B. Optical Bandpass Filters

Optical bandpass filters are a class of optical filters. Optical filters are optical elements placed in a light path that block specific wavelengths. Filters can be based on absorption or reflection of light, as well as on interference. Optical bandpass filters transmit one or more range of wavelengths, blocking both lower and higher wavelengths. In fluorescence microscopy, optical bandpass filters are used to selectively transmit the light emitted by the fluorescent targets while blocking the light at other wavelengths such as excitation light, autofluorescence, etc.

C. Lasers

A laser is a device emitting amplified light through stimulated emission of radiation. It is used for many applications such as surgery, fiber-optic communication, optical disk drives, and more. In fluorescence microscopy, lasers are used for their high intensity, monochromatic, coherent illumination.

In some embodiments, the method may use a laser having a wavelength in the Ultra-violet (UV, from about 10 to 400 nm), visible (from about 400 to 750 nm), Infra-Red (IR, from about 750 nm to 1 mm), or microwave (from about 1 mm to 0.3 m) range.

D. Methods of Using Drift Control Markers in Super-Resolution Microscopy

Drift control markers, as described in Section II below, may be used in super-resolution imaging. Such approaches could be useful for imaging any biological or non-biological samples, including but not restricted to cells, proteins, nucleic acids, lipids, sugars.

Drift control markers herein may be used to align images obtained during super-resolution microscopy. Because super-resolution microscopy collects multiple images over a long period of time and evaluates a small feature scale, sample drift or movement can be highly problematic and may be corrected to obtain higher quality images. Small environmental disturbances (e.g. mechanical vibrations and thermal fluctuations) can cause sample drift on the order of 0.1-10 nm/s, while image acquisition times can stretch from minutes to hours. Thus, to obtain the best possible resolution (such as a resolution of <50 nm with localization-based microscopy) sample drift may be corrected using drift compensation markers.

Investigators can use computer analysis to align images based on the location of drift control markers in the field of view of the imaging. The drift compensation markers herein offer advantages because they are at least one of the following: 1) stationary over the experimental duration; 2) the signal is wavelength shifted from the excitation light and its intensity depends less on the blocking power of the optical filters; 3) brightness can be optimized by using different reporter molecules; 4) inert to surrounding environment and will not interact (e.g. plasmonically) with molecules in solution resulting in intensity fluctuations; 5) less likely to aggregate and thus less likely to lead to inconsistent brightness and dispersion in the field of view.

To be effective, at least one DCM may be present in a field of view. With one DCM, drift due to translation of the field of view can be corrected. Multiple DCM in a field of view allow for correction of rotation and scale drift in addition to translation.

In some embodiments, multiple drift control markers in a single field of view can also be used as fiducials to overlay a series of images with high precision. In such a case, several drift control markers (such as about 2, 3, 4, or 5 or in some cases about 3-5) may be present in the field of view to help image processing software correctly orient and align each image to be overlaid. In other embodiments, as long as one drift control marker is present in the field of view, the drift control marker provides advantages in the experiment.

This application of having multiple DCMs in the field of view provides benefits for multiplexed imaging in super-resolution microscopy, where multiple biomarkers are analyzed in the same sample.

### II. Drift Compensation Markers

The present improved methods of super-resolution fluorescence microscopy employ improved drift compensation markers.

A. Plasmonic Particles

By plasmonic particle, we mean a particle whose electron density can couple with electromagnetic radiation of wavelengths that are far larger than the particle due to the nature of the dielectric-particle interface between the medium and the particles, as distinguished from so-called pure metals where there is a maximum limit on what size wavelength can be effectively coupled based on the material size.

The plasmonic particles may be nanoparticles, with a small size of about 100 nm or less, 90 nm or less, 80 nm or less, 70 nm or less, 60 nm or less, 50 nm or less, 40 nm or less, 30 nm or less, 20 nm or less, 10 nm or less, or 5 nm or less.

In some embodiments, the plasmonic particle is an isotropic particle from about 2 to 300 nm or from about 2 to 500 nm in diameter. In some embodiments, the plasmonic particle is an anisotropic particle with a size from about 2 to 300 nm or from about 2 to 500 nm in at least one dimension. In some embodiments, the plasmonic particle is an anisotropic particle with a size from about 2 to 300 nm or from about 2 to 500 nm in all dimensions. In some embodiments, a one dimensional particle, such as a nanowire, can have dimensions ranging from about 1 nm to about 500 μm in at least one dimension. In some embodiments, a one dimensional particle, such as a nanowire, can have dimensions ranging from about 1 nm to about 500 μm in all dimensions. Any of these size dimensions could apply to plasmonic particles or the outer dimensions of coated drift control markers.

In some embodiments, the plasmonic particle is a non-spherical geometric shape including but not limited to elliptical, triangular, rod, prism, plate, disk, hollow sphere, star, and wire shape.

Plasmonic particles can be made out of materials including but not restricted to gold, silver, platinum, copper, aluminum, carbon, cobalt, zinc, palladium, as well as their alloys, composites, and hybrid layered materials such as a core of one plasmonic material with a shell of a different plasmonic material.

Plasmonic particles may offer constant brightness, brightness that is on the same order of magnitude as the experimental signal, and minimal variation in signal intensity between different illumination sources and detection platforms. In some embodiments, the reflectivity of the plasmonic particle is the only signal generated by the drift control marker. In other embodiments, a reporter molecule may be added, as described in Section II.A.3, below to provide additional signaling from the drift control marker.

1. Coated Plasmonic Particles

In some embodiments, the drift compensation marker may comprise at least one transparent coating. Coating offers many benefits, including but not limited to inertness, resistance to aggregation in solution or on surfaces, insulation of the particle from its environment, and resistance to non-specific binding. Moreover, coated drift compensation markers allow the use of multiple different types of DCMs, each having a different intrinsic surface chemistry, without having to optimize microscopy conditions for each type of particle/surface chemistry. In addition, coated DCM are easier to functionalize with chemistry that allows attachment to surfaces.

Coated nanoparticles have been used in other situations and are thus previously described in the art. Acceptable coatings include, but are not limited to, biomolecular coatings such as proteins, polymer coatings such as polyethylene glycol or PEG, and oxide coatings. The oxide layer coating may include at least one metal including but not limited to Ti, Fe, Cu, Zn, Y, Zr, Nb, Mo, In, Si, Sn, Sb, Ta, W, Pb, Bi, and Ce and having a valence of from 2 to 6. The form of the oxide may include for example SiO₂, TiO₂, Fe₂O₃, CuO, ZnO, Y₂O₃, ZrO₂, In₂O₃, SnO₂, Sb₂O₅, WO₃, or PbO. These metal oxides may be doped or used alone or in combination with other types of coatings. In some embodiments, the coating is silica (also known as SiOx, where x=1.2-2, or glass). Other types of coatings include but are not limited to metals, metal nitrides, unimolecular molecular layer-type coatings such as self-assembled organothiol monolayers (SAMs), and any synthetic or naturally occurring macromolecule, such as a lipid, carbohydrate, polysaccharide, protein, polymer, glycoproteins, glycolipids. In some embodiments, the coating is an inert material.

By transparent, we mean the ability of a coating to transmit light without appreciable scattering, such as the ability, for example, to transmit at least 80% of light through a sample of the coating material at a thickness at least an atomic monolayer to a micrometer or more.

In some embodiments, the coating may be silica. Silica coated plasmonic particles are commercially available for a both isotropic and anisotropic particle shapes. Moreover, using Stober chemistry and variants thereof, it is possible to coat particles of diameters from about 5-250 nm with glass coatings as thin as about 1-2 nm, and as thick as about 100 nm or even more. Compared to Au or Ag nanoparticles, or other uncoated metal nanoparticles, silica-coated particles are far more resistant to aggregation. Moreover, if the particles do come into proximity with one another, it is by a physical agglomeration (that is reversible). In contrast, uncoated metal nanoparticles have been shown to aggregate irreversibly.

In some embodiments, the thickness of the coating ranges from about 1 to 20 nm, from about 1 to 100 nm, or about 100 nm or more.

In some embodiments, the plasmonic particle has at least one reporter molecule on its surface as discussed below in Section II.A.3 and an exterior coating over the combined plasmonic particle and at least one reporter molecule. Placing the reporter molecule inside the coating further protects the reporter molecule from either physical or chemical stresses.

Coating the plasmonic particle may also protect the sample from denaturation. Certain plasmonic particles, such as for instance gold or copper, may denature certain biomolecules (including peptides and proteins, including those that are sulfur-based) in samples of interest, causing unwanted three-dimensional conformational changes either before or during the super-resolution imaging process. Coating plasmonic particles may eliminate or reduce the potential for biomolecule denaturation in the sample.

A single coating may be applied to the plasmonic particle in some embodiments. In other embodiments, multiple layers of coating may be applied to the plasmonic particles. For example, different types of coating may be applied to further protect the plasmonic particle. In embodiments where at least one reporter molecule is used, the reporter molecule may be placed on the surface of an inner coating and an outer coating may protect the reporter molecule. If multiple types of reporter molecules are used, they may be separated by different layers of coating.

2. Shape of Plasmonic Particles

A variety of plasmonic nanoparticle sizes, shapes, and compositions can be used for particles, including but not limited to spheres, and near-spherical particles. Spheres and near-spherical particles are referred to as isotropic particles. A sphere has an identical diameter when measured across any axis of the particle. A near-sphere has a diameter that only varies by less than about 10% when measured across any axis of the particle. Likewise, there are an enormous variety of anisotropic plasmonic particles that may be used, including but not limited to oblate and prolate spheroids, prisms, tetrahedra, rods, cubes, plates, discs, and any other geometric shape that is anisotropic. For example, an anisotropic particle includes any non-spherical geometric shape including, but not limited to, elliptical, triangular, rod, prism, plate, disc, hollow sphere, star, and wire shape. Anisotropic particles may be considered three dimensional, two dimensional, or one dimensional. A particle is considered two dimensional when two of its dimensions are at least a hundred times greater than the third. A one-dimension particle has one dimension at least a hundred times greater than the other two. An anisotropic particle has a diameter that varies by at least 10% when measured across two axes of the particle, wherein the two axes selected have the largest and smallest diameters of any axes of the particle.

The interior of either isotropic or anisotropic particles can be partially or fully hollow, or the interior of these particles can be solid.

Anisotropic particles have previously been described in the literature for uses in other methods, including including biomedical engineering, optical sensing, catalysis, nanoelectronics.²³⁻²⁶

3. Plasmonic Particles Comprising at Least One Reporter Molecule

Reporter molecule, as used herein, means any substance that can be observed by collecting the photons coming from that substance when illuminated by electromagnetic energy.

The photons from the reporter molecules can be of different origins, including but not restricted to, fluorescence, phosphorescence, luminescence, or Raman scattering.

Excitation of the reporter molecules may include radiation energy in the visible light range, ultra-violet (UV), microwave, or Infra-Red (IR) range.

A reporter molecule may be employed on the surface of the plasmonic particle. This provides for an enhanced signal when a reporter molecule is in proximity to a plasmonic particle.

The reporter molecule can form a sub-monolayer, a complete monolayer, or a multilayer assembly on the surface of the plasmonic particle or a coating, or within a coating.

A reporter molecule may include, but is not restricted to, a fluorophore, luminophores, chemiluminescent, phosphorescent, or a spectroscopy-active molecule or compound, such as Raman-active molecules or compounds.

A reporter molecule can be a single species of reporter molecule, a mixture of different species of reporter molecules, a mixture of fluorescent molecules and Raman-active molecules, or a mixture of reporter molecules and molecules without measurable fluorescence or Raman activity.

Common reporter molecules include but are not limited to Alexa Fluor® 350, Alexa Fluor® 647, Cy™3B, fluorescein 5-isothiocyanate (FITC), 4′,6-diamidino-2-phenylindole (DAPI), Lucifer Yellow, BODIPY™, TOTO, coumarin, metal-ligand complexes, as well as organic compounds having aromatic ring structures including but not limited to NADH, FAD, tyrosine, tryptophan, purines, pyrimidines, trans-1,2-bis(4-pyridyl)ethylene (BPE), pyridine, 2-mercaptopyridine, furonitrile, imidazole, and para-nitroso-N,N′-dimethylaniline (p-NDMA), lipids, fatty acids, nucleic acids, nucleotides, nucleosides, amino acids, proteins, peptides, DNA, RNA, sugars, and vitamins.

In some embodiments, a reporter molecule will have an enhanced signal when excited in proximity to a plasmonic nanoparticle, such as a noble metal nanoparticle (including but not restricted to silver and gold). This enhanced activity is described as a surface enhanced fluorescence (SEF) signal in the case of a fluorescent reporter molecule, or surface enhanced Raman scattering (SERS) signal in the case of a Raman-active molecule. The phenomenon results from an “antenna” effect that increases the local electric field at the reporter molecule, which increases the flux of emitted or scattered photons.

In some embodiments, the reporter molecule may be placed on the surface of the plasmonic particle, optionally with a coating on the outside. In other embodiments, a first coating may be applied to the plasmonic particle, the coating labeled with a reporter molecule, and optionally a second coating applied if additional protection of the reporter molecule is desired. For example, in one embodiment a plasmonic particle may be coated with a coating of thickness ranging between an atomic monolayer and 50 nm, and then the fluorophore affixed to the outer surface of the coating, such that the distance between the fluorophore and the metal nanoparticle surface is 50 nm or less. In some embodiments, the coating can protect the reporter molecule from the microscopy solution, allowing for a more stable reporter molecule signal in some embodiments.

In some embodiments, the reporter molecule is dispersed and embedded within the coating.

In some embodiments, such as when drift control markers are used in PAINT experiments, a user may desire that that diffusing fluorophores in solution are not subjected to an enhanced signal when they encounter a drift compensation marker. Thus, in some embodiments, an SEF-based drift compensation marker comprises a fluorophore affixed at a distance from about 1 to 50 nm from the particle surface, separated by a first inert coating, and containing a second inert coating of thickness from about 20 to 250 nm, such that the distance from the metal nanoparticle surface to solution is from about 70 to 300 nm.

SERS-active particles that may be used as drift control markers include those described in U.S. Pat. Nos. 6,514,767, 6,861,263, 7,443,489, 7,723,100, 8,497,131, and 9,239,327.

Unlike the prior use of Raman-active reporter molecule particles, in certain embodiments, some of the present embodiments do not employ a Raman spectrometer. A typical spectrum of a SERS-based DCM consists of a number of Raman bands of varying intensity, corresponding to inelastically-scattered photons with different energies. In the presence of a monochromator, prism, or other wavelength-separating optical elements, the different-energy photons end up physically separated in space, and impinge upon an array of detection elements e.g. a CCD all at once. Alternatively, wavelength filtering devices allow single-energy photons to reach the detection element, one at a time. In either case, though, there is a deliberate intent and need to not detect all emitted photons in a single channel at a single time.

Unlike traditional Raman spectrometry, in some embodiments, when SERS-based particles tags are used as drift control markers, all the wavelength-shifted SERS photons are emitted at once, all pass through the bandpass filter, and are all detected at once, effectively integrating the SERS spectrum into a single, more intense signal, distinguishing their use from prior Raman spectrometry.

B. Nonplasmonic Raman-Active Particles

In some embodiments, the drift control marker may be a nonplasmonic, Raman-active particle. Specifically, drift control markers include particles that are detected by Raman-shifted photons. Diamond, for example, has a very intense Raman band at around 1332 cm-1. Using 632.8 nm excitation, the Raman-shifted photons are at around 691 nm, which are well separated from the laser excitation line. The longer the laser excitation wavelength, the further separated in nm a given Raman band appears. Thus, for 785 nm excitation, the diamond Raman band is at 876.6 nm. Carbon-based materials, including but not limited to diamond, diamond-like materials (a class of amorphous carbon that displays some of the typical characteristics of diamond; see Ferrari, Diamond and Related Materials 11:1053-1061 (2002)), graphites, graphenes, reduced graphenes, and graphene oxides, all yield intense Raman spectra, and thus comprise possible compositions for Raman-based DCM materials. Silicon-based materials, such a silicon and silicon-carbide, also comprise possible compositions for non-plasmonic, Raman-active DCM materials.

In some embodiments, such nonplasmonic, Raman-active particles may be coated particles described in Section II.A.1 above or anisotropic particles as described in Section II.A.2 above, modifying nonplasmonic, Raman-active particles to the references to plasmonic particles in those sections.

The nonplasmonic, Raman-active particles may be nanoparticles, with a small size of about 100 nm or less, 90 nm or less, 80 nm or less, 70 nm or less, 60 nm or less, 50 nm or less, 40 nm or less, 30 nm or less, 20 nm or less, 10 nm or less, or 5 nm or less.

In some embodiments, the nonplasmonic, Raman-active particle is an isotropic particle from about 2 to 300 nm or from about 2 to 500 nm in diameter. In some embodiments, the nonplasmonic, Raman-active particle is an anisotropic particle with a size from about 2 to 300 nm or from about 2 to 500 nm in at least one dimension. In some embodiments, the nonplasmonic, Raman-active particle is an anisotropic particle with a size from about 2 to 300 nm or from about 2 to 500 nm in all dimensions. In some embodiments, a one dimensional particle, such as a nanowire, can have dimensions ranging from about 1 nm to about 500 μm in at least one dimension. In some embodiments, a one dimensional particle, such as a nanowire, can have dimensions ranging from about 1 nm to about 500 μm in all dimensions. Any of these size dimensions could apply to nonplasmonic, Raman-active particles or the outer dimensions of coated drift control markers.

In some embodiments, the nonplasmonic, Raman-active particle is a non-spherical geometric shape including but not limited to elliptical, triangular, rod, prism, plate, disk, hollow sphere, star, and wire shape.

### EXAMPLES

### Example 1. Particle Immobilization

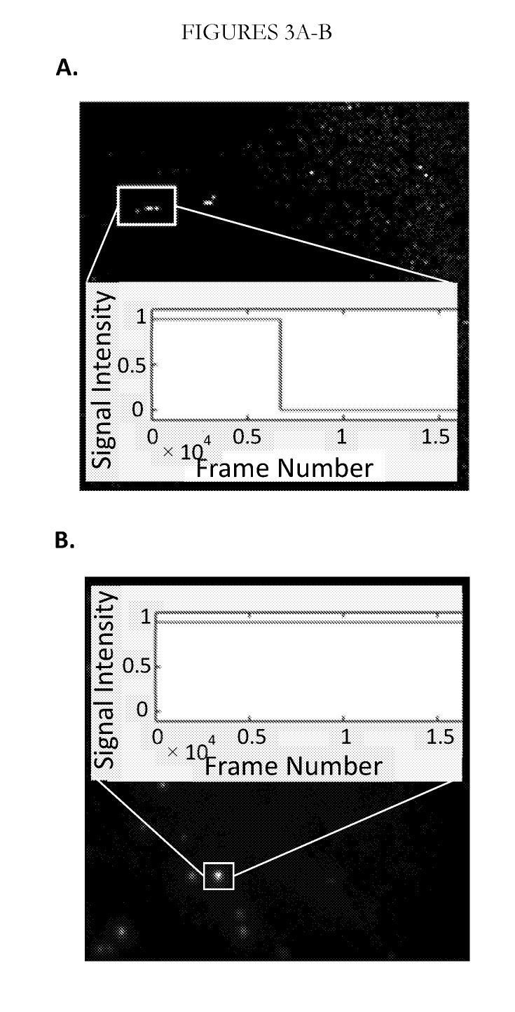

In this Example, the drift control marker remains immobilized on the substrate, and observable over the entire time course of imaging. The composition of the drift control particle will affect how well it is immobilized. FIG. 3 demonstrates the differences in drift marker immobilization based on particle composition.

HeLa cells were fixed in Lab Tek Coverglass Chambers. A 1:100 dilution of drift control markers (60 nm gold nanoparticles) in 1×PBS, pH 7.9, was incubated in one Lab Tek well for 15 minutes to allow the nanoparticles to settle and adhere to the substrate with fixed cells. In another Lab Tek well containing fixed cells, a 1:10,000 dilution of drift control markers (silica-coated gold SERS DCMs) in 1×PBS, pH 7.9, was added and allowed to incubate for 15 minutes. The reporter molecule used in the silica-coated gold SERS DCM was 1,2-bis(4-pyridyl)ethylene (BPE). Both wells were washed with 1×PBS prior to imaging.

Samples were loaded onto an inverted Nikon Eclipse Ti microscope (Nikon Instruments) with a Perfect Focus System and Andor Zyla sCMOS camera. Highly inclined and laminated optical (HILO) illumination was obtained using an oil-immersion objective (CFI 20 Apo TIRF 100×, NA 1.49, Oil) and adjusting the angle of the incoming 640 nm excitation laser beam (25 mW power). Field of view was limited to 256×256 pixels. Image stacks were acquired with 100 ms exposure time, 2×2 binning pixel binning, and 20,000 frames.

Data was analyzed using custom-built software in MATLAB to obtain time-traces (i.e. signal intensity over time) for each drift control marker. FIG. 3 shows the reconstructed images obtained, with a square box outlining a single drift control particle and its associated time-trace over 16,000 frames (equivalent to ˜26 minutes). FIG. 3A clearly shows that the 60 nm gold nanoparticle is bright (signal intensity=1) for approximately 6500 frames (˜11 min), then goes dark (signal intensity=0) for the remaining frames. The disappearance of the gold nanoparticle is likely due to the particle dissociating from the glass surface such that it is no longer within the detection range of total internal reflection microscopy (TIRF). Comparatively, FIG. 3B shows that the silica-coated SERS DCMs yield consistently high signal intensity over the entire experimental duration. Silica-coated drift correction markers have a stronger adherence to the glass coverslip surface, and thus serve as better drift control markers than bare gold nanoparticles.

### Example 2. Plasmonic Effect

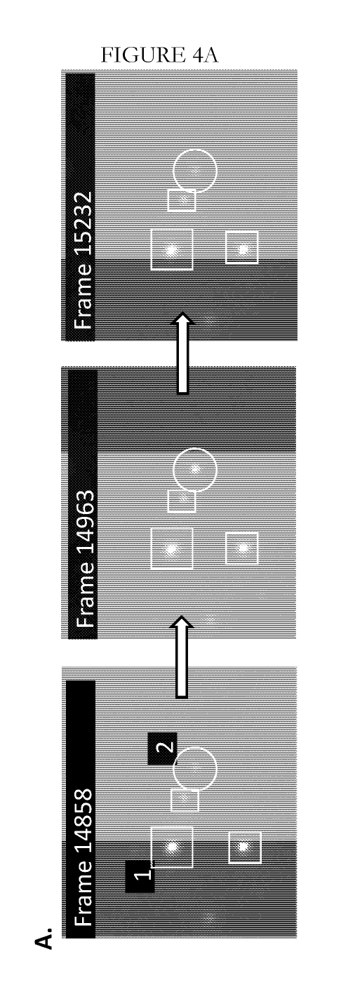

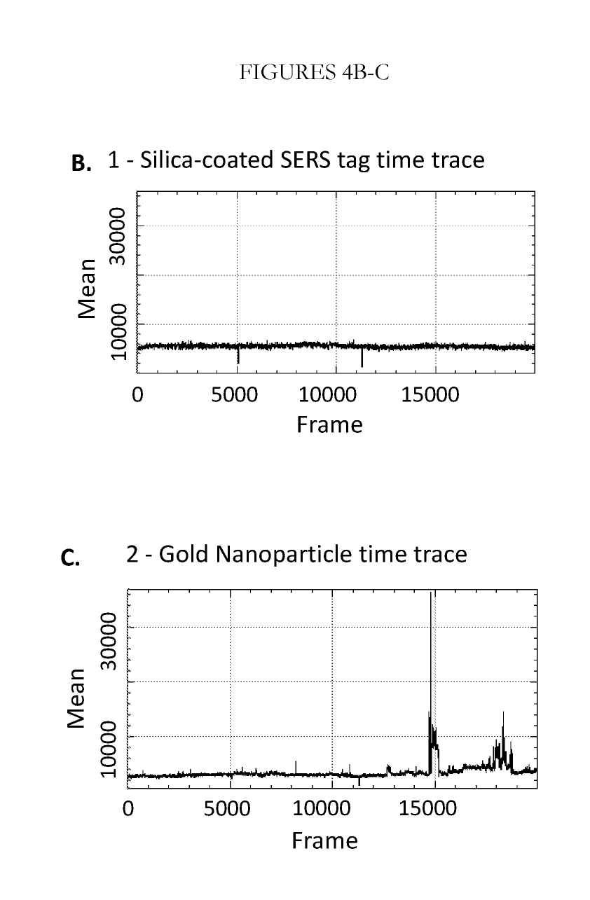

In this example, uncoated metal nanoparticles and coated SERS-based particles are immobilized on a biological sample. The sample is immersed with an aqueous solution containing fluorescent molecules. FIG. 4 presents the variation in time of the signal intensity for both types of particles and demonstrate the high fluctuation of the signal from the uncoated particles.

HeLa cells were fixed in Lab Tek Coverglass Chambers. The sample were loaded onto an inverted Nikon Eclipse Ti microscope (Nikon Instruments) with a Perfect Focus System and Andor Zyla sCMOS camera. Total Internal Reflection (TIR) illumination was obtained using an oil-immersion objective (CFI 20 Apo TIRF 100×, NA 1.49, Oil) and adjusting the angle of the incoming 640 nm excitation laser beam (25 mW power). The field of view was limited to 256×256 pixels, with 2×2 pixel binning. The exposure time was 100 ms.

A first image was recorded to obtain a background image. A 1:100 dilution of a first type of drift control markers (uncoated 60 nm gold nanoparticles) in 1×PBS, pH 7.9, was incubated in the Lab Tek well for 15 minutes to allow the nanoparticles to settle and adhere to the substrate with fixed cells. A second image of the same field of view was obtained and compared to the background image to identify the uncoated DCMs.

In the same well, a 1:10,000 dilution of a second type of drift control markers (silica-coated gold SERS DCMs) in 1×PBS, pH 7.9, was added and allowed to incubate for 15 minutes. An image was recorded and compared to the previous image to identify and localize the coated gold SERS DCMs.

Finally, a solution of oligonucleotide-conjugated fluorophores (Atto655) was added to the well, and a sequence of frames was recorded (20,000 frames, 100 ms exposure).

The resulting stack of frames was opened and analyzed in FIJI. FIG. 4A, shows the evolution a subset of the whole field of view over three frames with 4 particles identified as either uncoated gold DCM or coated gold SERS DCM. In the central frame, the particle 2 (uncoated gold DCM) exhibits a higher signal than in previous and following frames (left and right). Comparatively, the particles identified as coated gold SERS DCM do not show a significant intensity change. FIG. 4B shows the measured variation of signal intensity over the 20,000 frames for the selected particles shown in FIG. 4A. The signal for the uncoated gold nanoparticle (2) shows stochastic, and wide variations, while signal for the coated gold SERS particle (1) stays comparatively constant. The signal variation is attributed to surface enhanced fluorescence when a fluorophore conjugated oligonucleotide is in proximity of the uncoated nanoparticles.

### Example 3. Cellular Imaging

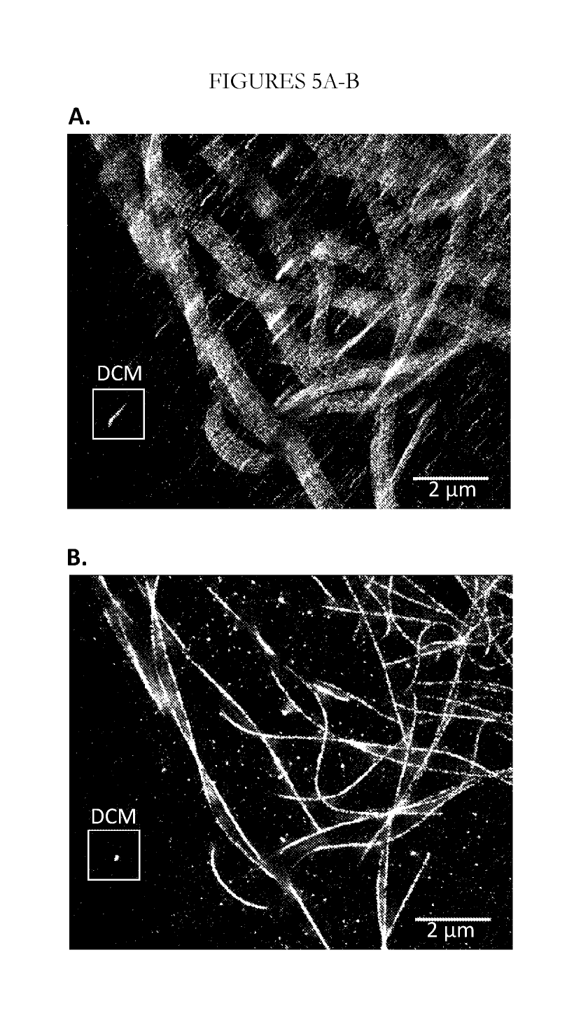

Super-resolution images of cells, cellular components, tissue, and other materials can be obtained using drift correction markers (DCM) in combination with microscopy techniques (e.g., STORM, PALM, SMLM, STED, SIM, PAINT, DNA-PAINT, etc.). To demonstrate the use of DCMs in microscopy, microtubules were imaged in fixed HeLa cells to achieve <70 nm resolution using the method of DNA-PAINT (FIG. 5).

HeLa cells were grown in Lab Tek Coverglass Chambers, fixed, and immunostained for alpha-tubulin with DNA-PAINT reagents. Cell chambers were rinsed with 1×PBS at pH 7.9. A 1:100 dilution of drift control markers (60 nm gold nanoparticles) capped with citrate was made in 1×PBS at pH 7.9. The diluted drift controls markers were added to fixed HeLa cells in Lab Tek chambers and allowed to settle on the surface for 15 minutes, then washed with 1×PBS. A 0.5 nM concentration of DNA-PAINT imager strands (DNA-conjugated fluorophore complementary to the conjugated DNA-PAINT antibodies) were added to the cell chambers prior to imaging.

Samples were loaded onto an inverted Nikon Eclipse Ti microscope (Nikon Instruments) with a Perfect Focus System and Andor Zyla sCMOS camera. Highly inclined and laminated optical (HILO) illumination was obtained using an oil-immersion objective (CFI 20 Apo TIRF 100×, NA 1.49, Oil) and adjusting the angle of the incoming 640 nm excitation laser beam (25 mW power). Field of view was limited to 256×256 pixels. Image stacks were acquired with 100 ms exposure time, 2×2 binning pixel binning, and 20,000 frames.

Image stacks were processed with custom-built software. As shown in FIG. 5A, the reconstructed image is initially blurry due to sample drift. Identification of a drift control marker in the field of view allows one to fit the directionality of the drift over time and correct for it, yielding the drift-corrected, highly-resolved image of microtubules in FIG. 5B.

### Example 4. Embodiments

The following numbered items constitute some of the embodiments described herein.

Item 1. A super-resolution fluorescence microscopy method comprising
a. providing a drift compensation marker, wherein
   i. the drift compensation marker comprises a plasmonic particle, wherein
      1. the drift compensation marker comprises a coated plasmonic particle;
      2. the drift compensation marker comprises an anisotropic plasmonic particle; and/or
      3. the drift compensation marker comprises a plasmonic particle comprising at least one reporter molecule on the surface of the plasmonic particle, on the surface of a coating, or embedded within a coating; or
   ii. the drift compensation marker comprises a nonplasmonic Raman-active particle and wherein
      1. optionally the drift compensation marker comprises a coated nonplasmonic Raman-active particle; and/or
      2. optionally the drift compensation marker comprises an anisotropic nonplasmonic Raman-active particle;
b. performing super-resolution fluorescence microscopy;
c. using the drift compensation marker to improve the resolution of the super-resolution fluorescence microscopy.

Item 2. The method of item 1, wherein the super-resolution fluorescence microscopy method is capable of resolution of better than about 250 nm.

Item 3. The method of item 2, wherein the super-resolution fluorescence microscopy method is capable of resolution from about 200 nm to 5 nm.

Item 4. The method of item 3, wherein the super-resolution microscopy method is capable of resolution from about 100 nm to 5 nm.

Item 5. The method of any one of items 1-4, wherein the resolution of the super-resolution fluorescence microscopy method is about 50 nm or better.

Item 6. The method of any one of items 1-5, wherein the resolution of the super-resolution fluorescence microscopy method is about 40 nm, 30 nm, 20 nm, 15 nm, 10 nm, 5 nm, or better.

Item 7. The method of any one of items 1-6, wherein the method employs a laser having a wavelength in the Ultra-violet (UV, from about 10 to 400 nm), visible (from about 400 to 750 nm), Infra-Red (IR, from about 750 nm to 1 mm), or microwave (from about 1 mm to 0.3 m) range.

Item 8. The method of any one of items 1-7, wherein the plasmonic particle comprises at least one of gold, silver, platinum, copper, aluminum, carbon, cobalt, zinc, or palladium, as well as their alloys, composites, or hybrid layered materials such as a core of one plasmonic material with a shell of a different plasmonic material.

Item 9. The method of item 8, wherein the plasmonic particle comprises at least one of gold, silver, copper, and carbon.

Item 10. The method of any one of items 1-7, wherein the nonplasmonic, Raman-active particle comprises at least one of diamond, diamond-like material, graphite, graphene, reduced graphene, and graphene oxide.

Item 11. The method of any one of items 1-10, wherein the plasmonic or nonplasmonic Raman-active particle is an isotropic particle from about 2 to 300 nm in diameter.

Item 12. The method of any one of items 1-10, wherein the plasmonic or nonplasmonic Raman-active particle is an anisotropic particle with a diameter from about 2 to 300 nm in any dimension.

Item 13. The method of any one of items 1-10 or 12, wherein the plasmonic or nonplasmonic Raman-active particle is a one-dimensional nanowire with a diameter from about 1 nm to about 500 μm in any direction.

Item 14. The method of any one of items 1-13, wherein the plasmonic or nonplasmonic Raman-active particle is coated with at least one transparent coating.

Item 15. The method of item 14, wherein the plasmonic particle or nonplasmonic Raman-active is coated with two or more layers of transparent coating.

Item 16. The method of any one of items 14-15, wherein the transparent coating comprises at least one of SiO₂, TiO₂, Fe₂O₃, CuO, ZnO, Y₂O₃, ZrO₂, In₂O₃, SnO₂, Sb₂O₅, WO₃, and PbO.

Item 17. The method of any one of items 14-16, wherein the transparent coating comprises at least one of metals, metal nitrides, unimolecular molecular layer-type coatings such as self-assembled organothiol monolayers (SAMs), and any synthetic or naturally occurring macromolecule, such as a lipid, carbohydrate, polysaccharide, protein, polymer, glycoproteins, glycolipids.

Item 18. The method of any one of items 14-17, wherein the thickness of the coating is from about 1 to 20 nm.

Item 19. The method of any one of items 14-17, wherein the thickness of the coating is from about 1 to 100 nm.

Item 20. The method of any one of items 14-17, wherein the thickness of the coating is about 100 nm or more.

Item 21. The method of any one of items 1-11 or 14-20, wherein the plasmonic or nonplasmonic Raman-active particle is isotropic.

Item 22. The method of any one of items 1-10 or 12-20, wherein the plasmonic or nonplasmonic Raman-active particle is anisotropic.

Item 23. The method of item 22, wherein the anisotropic plasmonic particle produces at least two distinct λ max signals when illuminated

Item 24. The method of any one of items 22-23, wherein the anisotropic plasmonic or nonplasmonic Raman-active particle is a non-spherical geometric shape comprising elliptical, triangular, rod, prism, plate, disk, hollow sphere, star, and wire shape.

Item 25. The method of any one of items 1-24, wherein the reporter molecule comprises excitable and radiative molecules comprising but not restricted to fluorophores, luminophores, chemiluminescent, phosphorescent, or Raman-active molecules.

Item 26. The method of any one of items 1-25, wherein the drift compensation marker comprises reporter molecules forming a sub-monolayer, a complete monolayer, or a multilayer assembly on the surface of the plasmonic particle or a coating, or within a coating.

Item 27. The method of any one of items 1-10, 12-20, or 22-26, wherein the drift compensation marker is coated and the plasmonic or nonplasmonic Raman-active particle is anisotropic.

Item 28. The method of any one of items 1-27, wherein the drift compensation marker is coated and the plasmonic particle comprises at least one reporter molecule on the surface of the plasmonic particle, on the surface of a transparent coating, or embedded within a transparent coating.

Item 29. The method of any one of items 1-28, wherein the plasmonic particle has a reporter molecule on its surface and is coated with at least one transparent coating.

Item 30. The method of any one of items 1-29, wherein the plasmonic particle has a first transparent coating, at least one reporter molecule on the surface of the coating, and a second outer transparent coating.

Item 31. The method of any one of items 1-10, 12-20, or 22-30, wherein the drift compensation marker comprises a plasmonic particle that is anisotropic and wherein the plasmonic particle comprises at least one reporter molecule on the surface of the plasmonic particle, on the surface of a transparent coating, or embedded within a transparent coating.

Item 32. The method of any one of items 1-10, 12-20, or 22-31, wherein the drift compensation marker comprises a coated plasmonic particle having at least one reporter on the surface of the plasmonic particle, on the surface of a transparent coating, or embedded within a transparent coating, further wherein the plasmonic particle is anisotropic.

### EQUIVALENTS

The foregoing written specification is considered to be sufficient to enable one skilled in the art to practice the embodiments. The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof.

As used herein, the term about refers to a numeric value, including, for example, whole numbers, fractions, and percentages, whether or not explicitly indicated. The term about generally refers to a range of numerical values (e.g., +/−5-10% of the recited range) that one of ordinary skill in the art would consider equivalent to the recited value (e.g., having the same function or result). When terms such as at least and about precede a list of numerical values or ranges, the terms modify all of the values or ranges provided in the list. In some instances, the term about may include numerical values that are rounded to the nearest significant figure.

### REFERENCES

1. Rust, M. J., Bates, M. & Zhuang, X. W. Sub-diffraction-limit imaging by stochastic optical reconstruction microscopy (STORM). Nat Methods 3, 793-795 (2006).
2. Hell, S. W. & Wichman, J. Breaking the diffraction resolution limit by stimulated emission: stimulated-emission-depletion fluorescence microscopy. Opt. Lett. 19, 780-782 (1994).
3. Klar, T. a, Jakobs, S., Dyba, M., Egner, a & Hell, S. W. Fluorescence microscopy with diffraction resolution barrier broken by stimulated emission. Proc. Natl. Acad. Sci. U.S.A. 97, 8206-8210 (2000).
4. Gustafsson, M. G. L. Nonlinear structured-illumination microscopy: wide-field fluorescence imaging with theoretically unlimited resolution. Proc. Natl. Acad. Sci. U.S.A. 102, 13081-13086 (2005).
5. Sharonov, A. & Hochstrasser, R. M. Wide-field subdiffraction imaging by accumulated binding of diffusing probes. Proc. Natl. Acad. Sci. U.S.A. 103, 18911-18916 (2006).
6. Betzig, E. et al. Imaging Intracellular Fluorescent Proteins at Nanometer Resolution. Science (80-.). 313, 1642-1645 (2006).
7. Hess, S. T., Girirajan, T. P. K. & Mason, M. D. Ultra-High Resolution Imaging by Fluorescence Photoactivation Localization Microscopy. Biophys. J. 91, 4258-4272 (2006).
8. Gustafsson, M. G. Surpassing the lateral resolution limit by a factor of two using structured illumination microscopy. J. Microsc. 198, 82-87 (2000).
9. Lee, S. H. et al. Using fixed fiduciary markers for stage drift correction. Opt. Express 20, 12177-83 (2012).
10. Tang, Y., Wang, X., Zhang, X., Li, J. & Dai, L. Sub-nanometer drift correction for super-resolution imaging. Opt. Lett. 39, 5685-8 (2014).
11. Geisler, C. et al. Drift estimation for single marker switching based imaging schemes. Opt. Express 20, 7274 (2012).
12. Wang, Y. et al. Localization events-based sample drift correction for localization microscopy with redundant cross-correlation algorithm Opt. Express 22, 15982-91 (2014).
13. Elmokadem, A. & Yu, J. Optimal Drift Correction for Superresolution Localization Microscopy with Bayesian Inference. Biophys. J. 109, 1772-1780 (2015).
14. Mlodzianoski, M. J. et al. Sample drift correction in 3D fluorescence photoactivation localization microscopy. Opt. Express 19, 15009 (2011).
15. Guizar-Sicairos, M., Thurman, S. T. & Fienup, J. R. Efficient subpixel image registration algorithms Opt. Lett. 33, 156-158 (2008).
16. McGorty, R., Kamiyama, D. & Huang, B. Active Microscope Stabilization in Three Dimensions Using Image Correlation. Opt. nanoscopy 2, 1-7 (2013).
17. Hwang, W., Bae, S. & Hohng, S. Autofocusing system based on optical astigmatism analysis of single-molecule images. Opt. Express 20, 29353-60 (2012).
18. Grover, G., Mohrman, W. & Piestun, R. Real-time adaptive drift correction for super resolution localization microscopy. Opt Express 23, 195-200 (2015).
19. Carter, A. R. et al Stabilization of an optical microscope to 0.1 nm in three dimensions. Appl. Opt. 46, 421-427 (2007).
20. Bon, P. et al. Three-dimensional nanometre localization of nanoparticles to enhance super-resolution microscopy. Nat. Commun. 6, 7764 (2015).
21. Dedecker, P., Mo, G. C. H., Dertinger, T. & Zhang, J. Widely accessible method for superresolution fluorescence imaging of living systems. Proc. Natl. Acad. Sci. 109, 10909-10914 (2012).
22. Szymborska, A. et al. Nuclear pore Scaffold Structure Analyzed by Super-Resolution Microscopy and Particle Averaging. Science (80-.). 341, 655-658 (2013).
23. Li, N., Zhao, P. & Astruc, D. Anisotropic gold nanoparticles: Synthesis, properties, applications, and toxicity. Angew. Chemie—Int. Ed. 53, 1756-1789 (2014).
24. O'Brien, M. N., Jones, M. R., Kohlstedt, K. L., Schatz, G. C. & Mirkin, C. A. Uniform circular disks with synthetically tailorable diameters: Two-dimensional nanoparticles for plasmonics. Nano Lett. 15, 1012-1017 (2015).
25. Xue, C., Millstone, J. E., Li, S. & Mirkin, C. A. Plasmon-driven synthesis of triangular core-shell nanoprisms from gold seeds. Angew. Chemie—Int. Ed. 46, 8436-8439 (2007).
26. Millstone, J. E., Hurst, S. J., Métraux, G. S., Cutler, J. I. & Mirkin, C. A. Colloidal gold and silver triangular nanoprisms. Small 5, 646-664 (2009).

What is claimed is:

1. A super-resolution fluorescence microscopy method comprising
a. providing a drift compensation marker, wherein
i. the drift compensation marker comprises a plasmonic particle, wherein
(a) the drift compensation marker comprises a coated plasmonic particle;
(b) the drift compensation marker comprises an anisotropic plasmonic particle; and/or
(c) the drift compensation marker comprises a plasmonic particle comprising at least one reporter molecule on the surface of the plasmonic particle, on the surface of a coating, or embedded within a coating; or
ii. the drift compensation marker comprises a nonplasmonic Raman-active particle and wherein
(a) optionally the drift compensation marker comprises a coated nonplasmonic Raman-active particle; and/or
(b) optionally the drift compensation marker comprises an anisotropic nonplasmonic Raman-active particle;
b. performing super-resolution fluorescence microscopy;
c. using the drift compensation marker to improve the resolution of the super-resolution fluorescence microscopy.

2. The method of claim 1, wherein the super-resolution fluorescence microscopy method is capable of resolution of better than about 250 nm.

3. The method of claim 2, wherein the super-resolution fluorescence microscopy method is capable of resolution from about 200 nm to 5 nm.

4. The method of claim 3, wherein the super-resolution microscopy method is capable of resolution from about 100 nm to 5 nm.

5. The method of claim 1, wherein the plasmonic particle comprises at least one of gold, silver, platinum, copper, aluminum, carbon, cobalt, zinc, or palladium, as well as their alloys, composites, or hybrid layered materials such as a core of one plasmonic material with a shell of a different plasmonic material.

6. The method of claim 5, wherein the plasmonic particle comprises at least one of gold, silver, copper, and carbon.

7. The method of claim 1, wherein the nonplasmonic, Raman-active particle comprises at least one of diamond, diamond-like material, graphite, graphene, reduced graphene, and graphene oxide.

8. The method of claim 1, wherein the plasmonic or nonplasmonic Raman-active particle is an isotropic particle from about 2 to 300 nm in diameter.

9. The method of claim 1, wherein the plasmonic or nonplasmonic Raman-active particle is coated with at least one transparent coating.

10. The method of claim 9, wherein the transparent coating comprises at least one of SiO₂, TiO₂, Fe₂O₃, CuO, ZnO, Y₂O₃, ZrO₂, In₂O₃, SnO₂, Sb₂O₅, WO₃, and PbO.

11. The method of claim 9, wherein the transparent coating comprises at least one of metals, metal nitrides, unimolecular molecular layer-type coatings such as self-assembled organothiol monolayers (SAMs), and any synthetic or naturally occurring macromolecule, such as a lipid, carbohydrate, polysaccharide, protein, polymer, glycoproteins, glycolipids.

12. The method of claim 1, wherein the plasmonic or nonplasmonic Raman-active particle is anisotropic.

13. The method of claim 12, wherein the anisotropic plasmonic particle produces at least two distinct λ max signals when illuminated

14. The method of claim 12, wherein the anisotropic plasmonic or nonplasmonic Raman-active particle is a non-spherical geometric shape comprising elliptical, triangular, rod, prism, plate, disk, hollow sphere, star, and wire shape.

15. The method of claim 1, wherein the reporter molecule comprises excitable and radiative molecules comprising but not restricted to fluorophores, luminophores, chemiluminescent, phosphorescent, or Raman-active molecules.

16. The method of claim 1, wherein the drift compensation marker comprises reporter molecules forming a sub-monolayer, a complete monolayer, or a multilayer assembly on the surface of the plasmonic particle or a coating, or within a coating.

17. The method of claim 1, wherein the drift compensation marker is coated and the plasmonic or nonplasmonic Raman-active particle is anisotropic.

18. The method of claim 1, wherein the drift compensation marker is coated and the plasmonic particle comprises at least one reporter molecule on the surface of the plasmonic particle, on the surface of a transparent coating, or embedded within a transparent coating.

19. The method of claim 1, wherein the plasmonic particle has a reporter molecule on its surface and is coated with at least one transparent coating.

20. The method of claim 1, wherein the drift compensation marker comprises a plasmonic particle that is anisotropic and wherein the plasmonic particle comprises at least one reporter molecule on the surface of the plasmonic particle, on the surface of a transparent coating, or embedded within a transparent coating.

21. The method of claim 1, wherein the drift compensation marker comprises a coated plasmonic particle having at least one reporter on the surface of the plasmonic particle, on the surface of a transparent coating, or embedded within a transparent coating, further wherein the plasmonic particle is anisotropic.
